(19) United States
(12) Patent Application Publication
(10) Pub. No.: US 2011/0320229 A1
(43) Pub. Date: Dec. 29, 2011

(54) AGRONOMIC OPTIMIZATION BASED ON STATISTICAL MODELS

(75) Inventors: Sammy J. Stehling, Monmouth, IL (US); James H. Crain, Eureka, MO (US); Timothy D. Perez, Maryland Heights, MO (US)

(73) Assignee: MONSANTO TECHNOLOGY LLC, St. Louis, MO (US)

(21) Appl. No.: 13/123,435

(22) PCT Filed: Oct. 14, 2009
(86) PCT No.: PCT/US2009/060615

§ 371 Date: Aug. 18, 2011

Related U.S. Application Data
(60) Provisional application No. 61/105,417, filed on Oct. 14, 2008.

(51) Int. Cl. G06Q 10/00

(52) U.S. Cl. 705/7.12

(57) ABSTRACT

Generating a crop prescription using a computer coupled to a memory area includes receiving yield data for a plurality of crop population trials, wherein each trial is varied by at least one of a hybrid line, a population density, and a row spacing. At least one statistical model is generated based on the yield data to obtain a plurality of coefficients, which are stored in the memory area. A predicted yield for at least one selected hybrid line is determined based on the coefficients and a selected row spacing, and a predicted profit is determined for the at least one selected hybrid line based on the coefficients and the selected row spacing. A crop prescription is presented that includes a recommended hybrid line and population density for use by a grower.

### BACKGROUND

Recent years have witnessed an increase in the productivity of agricultural products. This increase in productivity may be attributed to various factors including ergonomics, technology advances in farm machinery, and/or hybrid seeds. However, due to a limited availability of land resources and/or labor, it is desirable to determine and optimize a relationship between the factors contributing to an increase in yield and the actual realized yield. Exemplary factors that may lead to an increase in yield include a hybrid line of planted crops, a population density of the planting, a spacing used between planting rows, and/or geographical conditions.

### SUMMARY

This Brief Description is provided to introduce a selection of concepts in a simplified form that are further described below in the Detailed Description. This Brief Description is not intended to identify key features or essential features of the claimed subject matter, nor is it intended to be used as an aid in determining the scope of the claimed subject matter.

In one aspect, a method is provided for generating a crop prescription using a computer coupled to a memory area. The method includes receiving, by the computer, yield data for a plurality of crop population trials, wherein each trial is varied by at least one of a hybrid line, a population density, and a row spacing. The method also includes generating at least one statistical model based on the yield data to obtain a plurality of coefficients and storing the coefficients in the memory area. In addition, the method includes determining a predicted yield and a predicted profit for at least one selected hybrid line based on the coefficients and a selected row spacing, and presenting a crop prescription that includes a recommended hybrid line and population density for use by a grower.

Another aspect provides a computer is coupled to a memory area for use in crop optimization based on yield data for a plurality of crop population trials each varied by at least one of a crop hybrid line, a population density, and a row spacing. The computer is programmed to receive a number of acres to be planted, determine a predicted yield and a predicted profit for each of a plurality of hybrid lines at each of a plurality of population densities based on a plurality of statistical model coefficients stored in the memory area, receive a selected row spacing and at least one hybrid line associated with at least one selected population density, and provide a number of seed bags of the at least one selected hybrid line necessary to plant the received number of acres.

In another aspect, one or more computer-readable storage media having computer-executable components are provided for generating a crop prescription using a computer coupled to a database. The components include a data reception component that causes at least one processor to receive yield data for a plurality of crop population trials, wherein each trial is varied by at least one of a hybrid line, a population density, and a row spacing. The components also include a statistics component that causes at least one processor to generate at least one statistical model based on the yield data to obtain a plurality of coefficients, a yield prediction component that causes at least one processor to determine a predicted yield for at least one selected hybrid line based on the coefficients, a profit prediction component that causes at least one processor to determine a predicted profit for the at least one selected hybrid line based on the coefficients, and a prescription component that causes at least one processor to present a crop prescription that includes a recommended hybrid line and population density for use by a grower.

In yet another aspect, a system is provided for generating a crop prescription for use by a grower. The information system includes a memory area and a computer system coupled to the memory area. The memory area is configured to store yield data for a plurality of crop population trials that include a plurality of hybrid lines, population densities, and row spacings. The computer system is configured to determine a predicted yield and a predicted profit for each of a plurality of hybrid lines at each of a plurality of population densities based on a plurality of statistical model coefficients stored in the database and a selected row spacing. The computer system is also configured to present a crop prescription that includes at least one selected hybrid line, a population density, and a predicted yield for a user-input acreage using the at least one selected hybrid line and population density for use by a grower.

### BRIEF DESCRIPTION OF THE DRAWINGS

The embodiments described herein may be better understood by referring to the following description in conjunction with the accompanying drawings.

FIG. 1 is a simplified block diagram of an exemplary information system for use in gathering and processing agricultural information.

FIG. 2 is an expanded block diagram of an exemplary embodiment of a system architecture of the information system shown in FIG. 1.

FIG. 3 is a simplified flowchart illustrating an exemplary method for generating a crop prescription for use by a grower using the information system shown in FIG. 1.

FIG. 4 is an expanded flowchart further illustrating the method shown in FIG. 3.

FIG. 5 is a screenshot of an exemplary data input view that may be used with the system shown in FIG. 1.

FIG. 6 is a screenshot of an exemplary dataset selection view that may be used with the system shown in FIG. 1.

FIG. 7 is a screenshot of an exemplary predicted yield matrix showing a raw yield that may be used with the system shown in FIG. 1.

FIG. 8 is a screenshot of an exemplary predicted yield matrix showing a yield above a minimum yield that may be used with the system shown in FIG. 1.

FIG. 9 is a screenshot of an exemplary predicted yield matrix showing a yield below a maximum yield that may be used with the system shown in FIG. 1.

FIG. 10 is a screenshot of an exemplary predicted yield matrix showing a yield above an average yield that may be used with the system shown in FIG. 1.

FIG. 11 is a screenshot of an exemplary predicted profit matrix showing a raw profit that may be used with the system shown in FIG. 1.

FIG. 12 is a screenshot of an exemplary crop prescription that may be used with the system shown in FIG. 1.

FIG. 13 is a screenshot of an exemplary yield comparison and profit comparison that may be used with the system shown in FIG. 1.

FIG. 14 is a simplified block diagram of an exemplary crop prescription process.

### DETAILED DESCRIPTION

The embodiments described herein relate generally to analyzing crop population trials and, more particularly, to generating a crop prescription based on crop population trials.

In some embodiments, the term “crop prescription” refers generally to an optimized set of agricultural inputs that may be used to create a preferred crop yield and/or profit. For example, based on inputs such as location, land cost, fertilizer cost, herbicide cost, insecticide cost, fungicide cost, seed cost, and an average expected moisture, a crop prescription may be generated that includes an optimum population by hybrid to provide an effective comparison of potential yield and profit for a grower.

In some embodiments, the term “row spacing” refers generally to a distance between adjacent rows of a planted crop. Examples of row spacing measurements as used herein include approximately twenty inches and approximately thirty inches. However, it should be understood that any suitable row spacing may be used.

In some embodiments, the term “population density” refers generally to a number of plantings per area. An example of a population density as used herein is measured in thousands of plants per acre. However, it should be understood that any suitable density measurement may be used.

Described in detail herein are exemplary embodiments of systems and methods that facilitate analyzing crop population trial yield data to obtain statistical model coefficients for use in generating determinations based on an individual field of which agricultural inputs, such as hybrid line, population density, row spacing, fertilizer, pesticide, and the like, to select. Moreover, determining the agricultural inputs facilitates, for example, maximizing yield and/or return on investment made to acquire and maintain the agricultural inputs.

Exemplary technical effects of the methods, systems, computers, and computer-readable media described herein include at least one of: (a) receiving yield data relating to a plurality of population trials; (b) analyzing the yield data to generate a plurality of statistical models that include model coefficients; (c) determining a predicted yield for each of a plurality of hybrid lines based on one or more selected regions and years of population trial data; (d) determining a predicted profit for each of the hybrid lines based on the selected regions and years of population trial data, a number of acres to be planted, and costs associated with the acreage; (e) generating and presenting a crop prescription matrix that illustrates a predicted yield and/or predicted profit for each hybrid line at each of a plurality of population densities; (f) generating a crop prescription for a grower, wherein the crop prescription includes one or more selected hybrid lines at one or more selected population densities; (g) generating a yield curve based on one or more selected hybrid lines in the crop prescription; and (h) generating a profit curve based on the selected hybrid lines in the crop prescription.

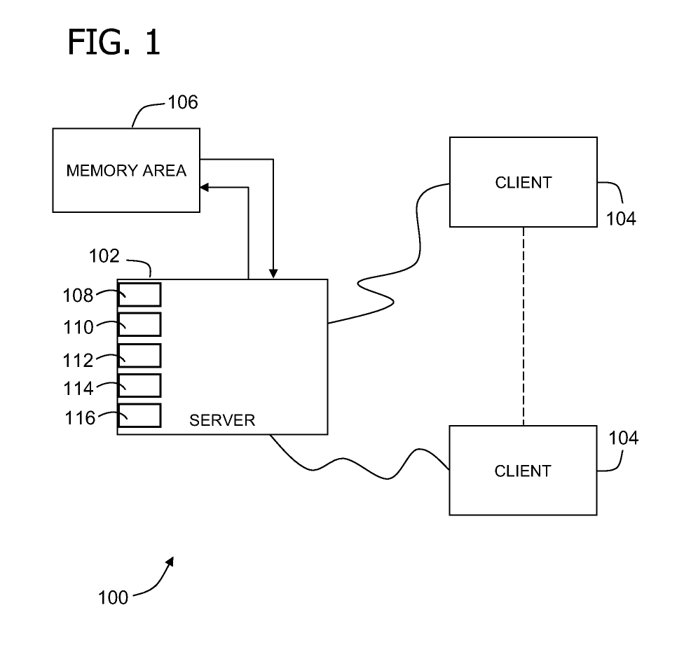

FIG. 1 is a simplified block diagram of an exemplary system 100 in accordance with one embodiment for use in gathering and processing agricultural information. In the exemplary embodiment, system 100 includes a server system 102, and a plurality of client sub-systems, also referred to as client systems 104, connected to server system 102. In one embodiment, client systems 104 are computers including a web browser and/or a client software application, such that server system 102 is accessible to client systems 104 over a network, such as the Internet and/or an intranet. Client systems 104 are interconnected to the Internet through many interfaces including a network, such as a local area network (LAN), a wide area network (WAN), dial-in-connections, cable modems, wireless modems, and/or special high-speed Integrated Services Digital Network (ISDN) lines. As described above, client systems 104 may be any device capable of interconnecting to the Internet including a computer, web-based phone, personal digital assistant (PDA), or other web-based connectable equipment. Server system 102 is connected to a memory area 106 containing information on a variety of matters, such as agricultural information relating to one or more geographical regions. In one embodiment, centralized memory area 108 is stored on server system 102 and is accessed by potential users at one of client systems 104 by logging onto server system 102 through one of client systems 104. In an alternative embodiment, memory area 108 is stored remotely from server system 102 and may be non-centralized. As discussed below, agricultural information including yield data related to population trials may be extracted by server system 102 for storage within memory area 108.

The embodiments illustrated and described herein as well as embodiments not specifically described herein but within the scope of aspects of the invention constitute exemplary means for generating a crop prescription for use by a grower, and more particularly, constitute exemplary means for archiving and analyzing agricultural data in memory area 106 to obtain the crop prescription. For example, server system 102 or client system 104, or any other similar computer device, programmed with computer-executable instructions stored on computer-readable storage media illustrated in FIG. 1 constitutes exemplary means for archiving and analyzing agricultural data in memory area 106 to obtain a crop prescription. Exemplary computer-readable storage media include a data reception component 108, a statistics component 110, a yield prediction component 112, a profit prediction component 114, and a prescription component 116.

In embodiments, data reception component 108 causes a processor to receive yield data for a plurality of crop population trials, wherein each trial is varied by at least one of a hybrid line, a population density, and a row spacing. Statistics component 110 causes a processor to generate at least one statistical model based on the yield data to obtain a plurality of coefficients. Yield prediction component 112 causes a processor to determine a predicted yield for at least one selected hybrid line based on the coefficients. Profit prediction component 114 causes a processor to determine a predicted profit for the at least one selected hybrid line based on the coefficients. Prescription component 116 causes a processor to present a crop prescription that includes a recommended hybrid line and population density for use by a grower.

Moreover, in embodiments, yield prediction component 112 determines a predicted yield for the at least one selected hybrid line based on a selected row spacing, and profit prediction component 114 determines a predicted profit for the at least one selected hybrid line based on a selected row spacing. In addition, in embodiments, statistics component 110 presents a crop prediction matrix that includes a plurality of rows of hybrid lines and a plurality of columns of population densities, yield prediction component 112 determines a predicted yield for each hybrid line at each population density, and profit prediction component 114 determines a predicted profit for each hybrid line at each population density.

Furthermore, in embodiments, yield prediction component 112 presents a yield curve for the at least one selected hybrid line, wherein the yield curve includes a comparison of predicted yield and population density for the at least one selected hybrid line. In addition, profit prediction component 114 presents a profit curve for the at least one selected hybrid line, wherein the profit curve includes a comparison of predicted profit and population density for the at least one selected hybrid line.

In embodiments, yield prediction component 112 presents a three-dimensional yield curve for the at least one selected hybrid line, wherein the yield curve includes a comparison of predicted yield and population density for each of a plurality of regions in the yield data. In addition, in embodiments, profit prediction component 114 presents a three-dimensional profit curve for the at least one selected hybrid line, wherein the profit curve includes a comparison of predicted profit and population density for each of a plurality of regions in the yield data.

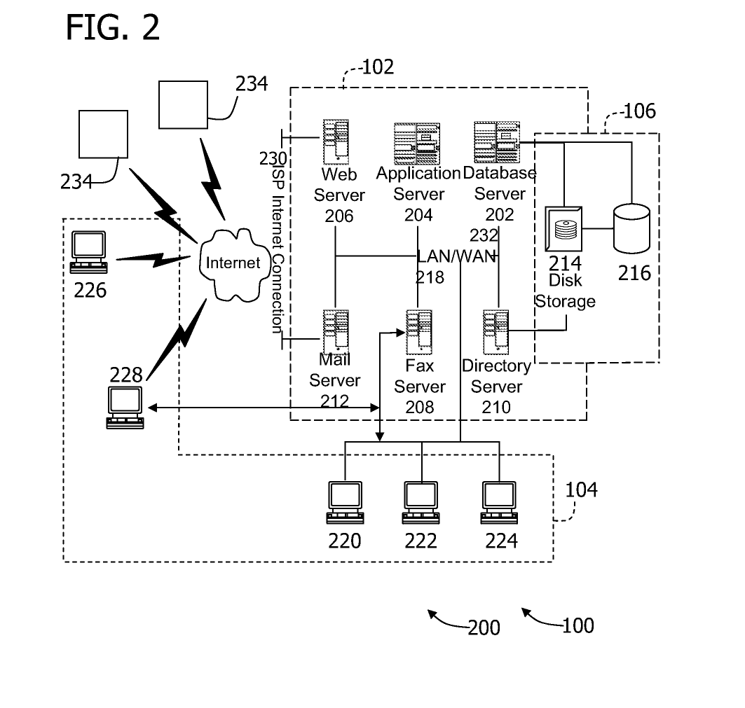

FIG. 2 is an expanded block diagram of an exemplary embodiment of a system architecture 200 of system 100 (shown in FIG. 1) in accordance with one embodiment. Components in system architecture 200, identical to components of system 100, are identified in FIG. 2 using the same reference numerals as used in FIG. 1. System 200 includes server system 102 and client systems 104. Server system 102 further includes a database server 202, an application server 204, a web server 206, a fax server 208, a directory server 210, and a mail server 212. Memory area 106 includes, for example, a disk storage unit 214, which is coupled to database server 202 and directory server 210. Examples of disk storage unit 214 include, but are not limited to including, a Network Attached Storage (NAS) device and a Storage Area Network (SAN) device. Memory area 106 also includes a database 216, which is coupled to database server 202. Servers 202, 204, 206, 208, 210, and 212 are coupled in a local area network (LAN) 218. Client systems 104 may include a system administrator workstation 220, a user workstation 222, and a supervisor workstation 224 coupled to LAN 218. Alternatively, client systems 104 may include workstations 220, 222, 224, 226, and 228 that are coupled to LAN 218 using an Internet link or are connected through an intranet.

Each client system 104, including workstations 220, 222, and 224, is a personal computer having a web browser and/or a client application. Server system 102 is configured to be communicatively coupled to client systems 104 to enable server system 102 to be accessed using an Internet connection 230 provided by an Internet Service Provider (ISP). The communication in the exemplary embodiment is illustrated as being performed using the Internet, however, any suitable wide area network (WAN) type communication can be utilized in alternative embodiments, that is, the systems and processes are not limited to being practiced using the Internet. In addition, local area network 218 may be used in place of WAN 232. Further, fax server 208 may communicate with remotely located client systems 104 using a telephone link.

In some embodiments, system 100 also includes one or more mobile device 234 including, without limitation, remote computers, laptop computers, personal digital assistants (PDAs), cellular phones, and/or smart phones. Mobile device 234 enables an agronomist, seed sales representative, and/or a grower to access a crop prescription tool from a remote location.

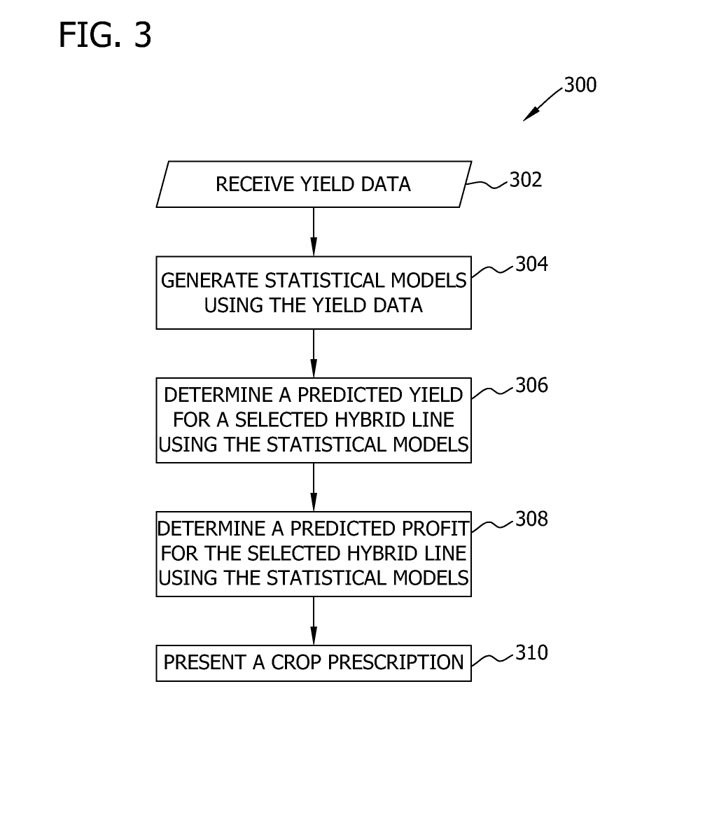

FIG. 3 is a flowchart 300 that illustrates an exemplary method for generating a crop prescription using system 200 (shown in FIG. 2). In the exemplary embodiment, system 100 receives 302 yield data. Specifically, server system 102 receives the yield data and stores the yield data in memory area 106. Server system 102 then analyzes the yield data to generate 304 a plurality of statistical models to obtain a plurality of coefficients based on population density, environment, and a population interaction that correlates the population density and environment.

In the exemplary embodiment, server system 102 determines 306 a predicted yield for one or more selected hybrid lines based on the coefficients. Moreover, server system 102 determines 308 a predicted profit for the one or more selected hybrid lines based on the coefficients. The yield and profit predictions are also based on user input received via client 104 and/or mobile device 234, including a number of acres to be planted, a market price of the crop, and other related costs. Server system 102 then presents 310 a crop prediction based on the one or more selected hybrid lines and the additional user input. The crop prediction includes data such as a number of seed bags needed, the predicted yield, and a total yield for the planted area.

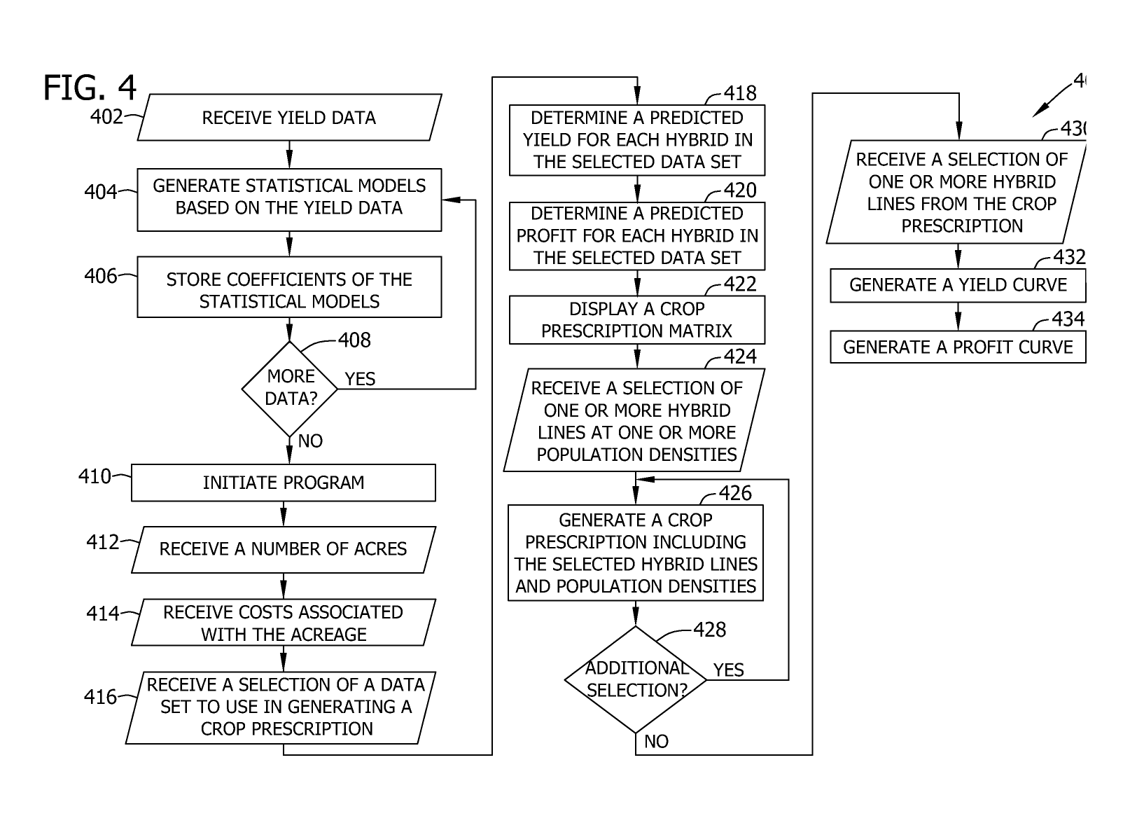

FIG. 4 is an expanded flowchart 400 further illustrating the method shown in FIG. 3. In the exemplary embodiment, and referring to FIG. 2, system 100 receives 402 yield data related to a plurality of population trials. The population trials include crop samples that are planted based on the variations of various parameters including, but not limited to a hybrid line being planted, a population density of the planting, and a spacing used between rows. The population samples are sown in the spring and are harvested upon ripening. Each trial of planting includes planting a crop such as corn in several plots, wherein each plot is defined as a small area (approximately 0.01 acre) of land. Each plot of land contains a sample population of the crop that is planted based on a combination of the above parameters. In an exemplary example, a trial may include sixteen hybrid varieties, five discrete population densities, and two discrete row spacings. It should be understood that any suitable combination of hybrid varieties, population densities, and row spacings may be used.

After the corn crop matures, the corn is harvested, and the yield for each plot per trial is recorded. The yield data thus obtained is extrapolated to yield a bushels per acre value for each plot based on the appropriate combination of hybrid line, population density, and row spacing. The yield results are grouped together based on factors such as geographical location, type of irrigation, and crop rotation. In some embodiments, the yield results are not grouped together based on geographical location, as described in more detail below.

Once the harvest data is recorded and grouped, it is analyzed by, for example, server system 102. For example, the yield data is input into a statistical modeling software to generate 404 statistical predictive models. The predictive models thus obtained, are used to derive important mathematical correlations between yield data and various planting parameters such as the hybrid line, population density, and row spacing. An example of a predictive model obtained from such an analysis is a polynomial equation that includes a plurality of coefficients based on a population density component, an environment component, and a population interaction component that correlates the population density and environment components. Such an equation is generated for each combination of hybrid line and row spacing. Each coefficient is stored 406 in memory area 106. Server system 102 also determines 408 whether additional data is present for analysis. If additional data is present, server system 102 again generates 404 statistical predictive models and stores 406 the resulting coefficients in memory area 106.

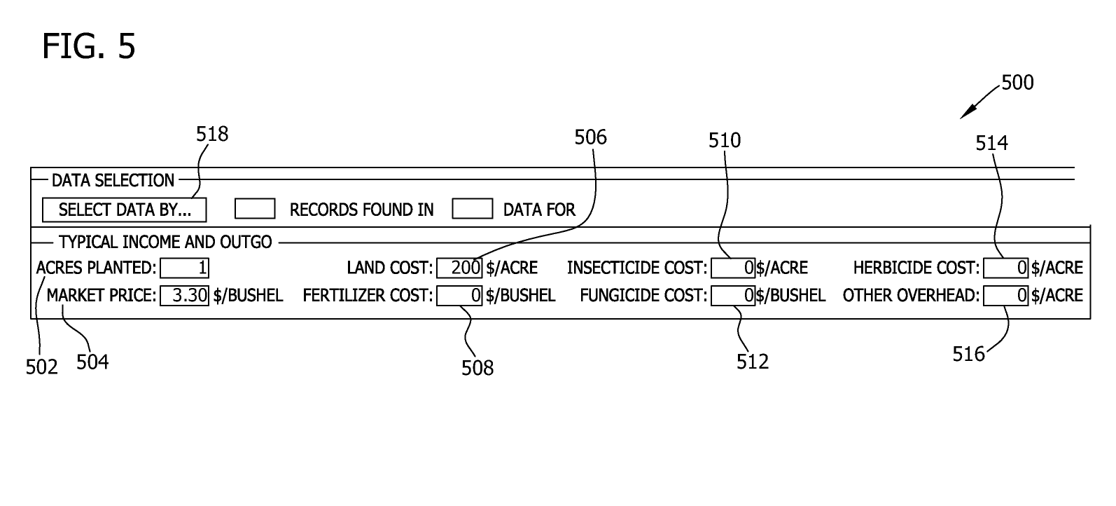

In the exemplary embodiment, and if no additional data is present, server system 102 initiates 410 a program using client 104, mobile device 234, or workstation 226 or 228. Specifically, application server 204 initiates the program. In some embodiments, application server 204 presents the program user interface to a user via web server 206. As shown in FIG. 5, a user is presented with a data input view 500. Application server 204 receives typical income and outgo values via data input view 500. For example, application server 204 receives 412 a number of acres planted 502 and a market price per bushel for the crop 504. Application server 204 also receives 414 a land cost 506, a fertilizer cost 508, an insecticide cost 510, a fungicide cost 512, an herbicide cost 514, and any other overhead cost 516. As shown in FIG. 5, each cost is measured on a per acre basis. However, any suitable measuring method may be used. Application server 204 stores the input acreage and cost data into memory area 106.

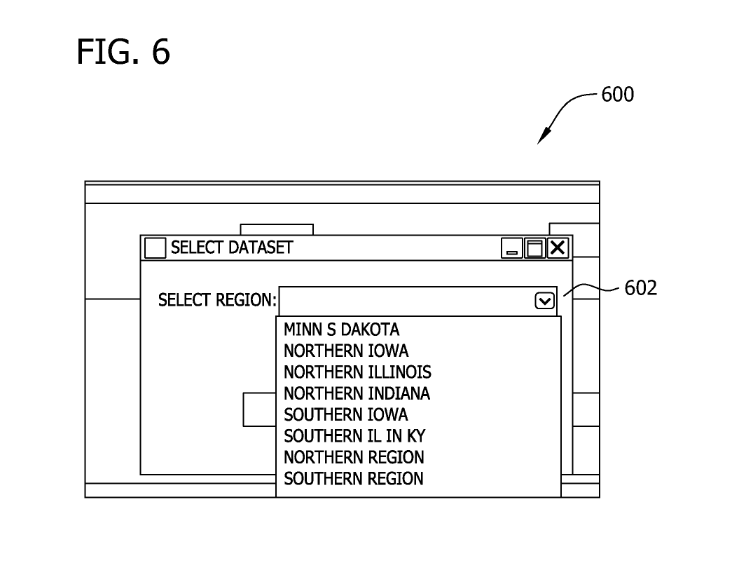

In addition, application server 204 receives 416 a user command to designate a data set. Specifically, application server 204 receives the command via a data set selection button 518. In response, and as shown in FIG. 6, application server 204 presents the user with a dataset selection view 600 that includes a dropdown list 602 of regions in which the population trials were conducted. For example, dropdown list 602 may include selections for an entire state, a portion of a state, and portions of two or more adjacent states. In addition, dropdown list 602 includes selections for aggregate regions that include data from one or more of the more localized selections. In the exemplary embodiment, the user may also be presented with a second dropdown list (not shown) that includes years during which the population trials were conducted. Moreover, in some embodiments, the user may configure the lists to include a subset of regions and/or years.

Referring again to FIG. 4, and in the exemplary embodiment, server system 102 determines 418 a predicted yield for each hybrid line in the selected data set after receiving acreage and cost information 502 through 516. More specifically, application server 204 determines the predicted yield for each hybrid line at each row spacing and population density. Application server 202 also determines 420 a predicted profit for each hybrid line in the selected data set based on acreage and cost information 502 through 516. More specifically, application server 204 determines the predicted profit for each hybrid line at each row spacing and population density. Application server 204 then generates a crop prescription matrix, which is displayed 420 to the user via, for example, workstations 220, 222, 224, 226, and 228, or mobile device 234.

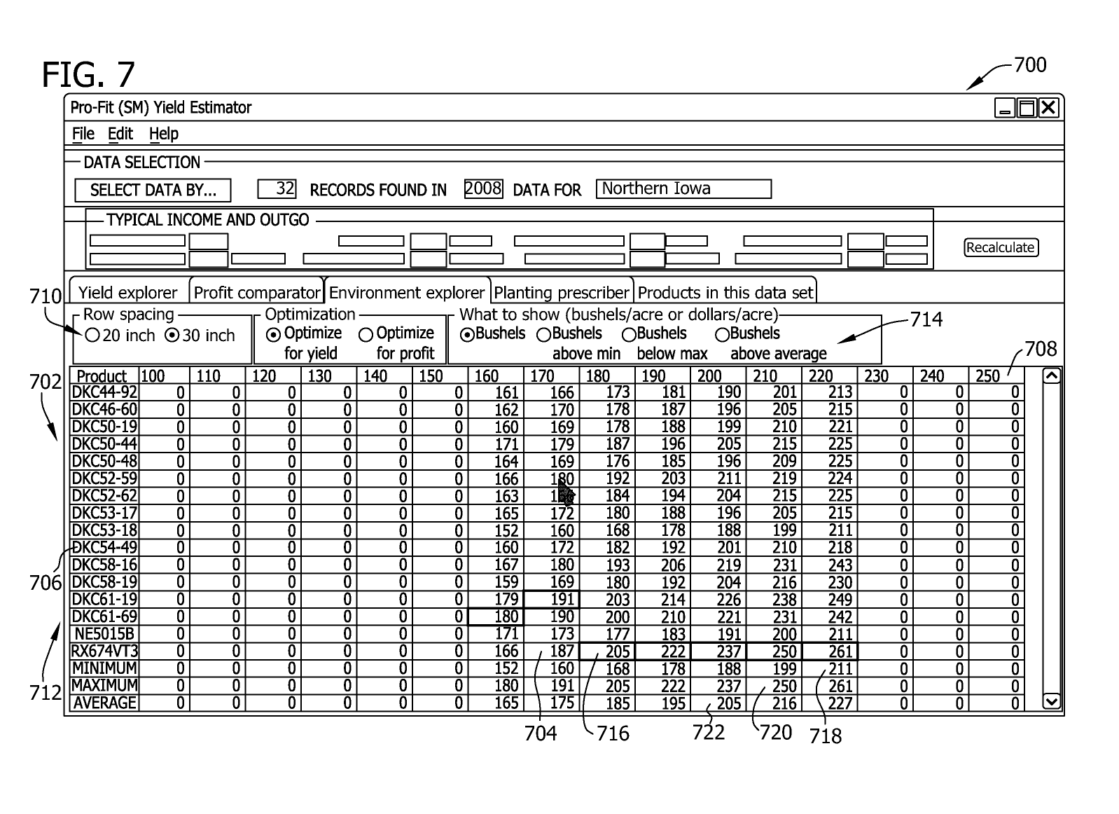

FIG. 7 is a view 700 of an exemplary predicted yield matrix 702 that displays a predicted yield 704 for each hybrid line 706 based on population density 708 and row spacing 710. Predicted yield view 700 includes a plurality of rows 712 that are each associated with a single hybrid line, and a plurality of columns 714 that are each associated with a single population density. In some embodiments, view 700 includes only columns 714 and rows 712 that have associated yield data stored in memory area 106. In the exemplary embodiment, view 700 includes predicted yield 704 for a selected row spacing 710. In response to a selection of a different row spacing 710, application server 204 updates, such as automatically updates, matrix 702. As shown in FIG. 7, a highest yield 716 for each population density 708 is highlighted. Moreover, matrix 702 includes a minimum yield 718, maximum yield 720, and average yield 722 for each population density 708.

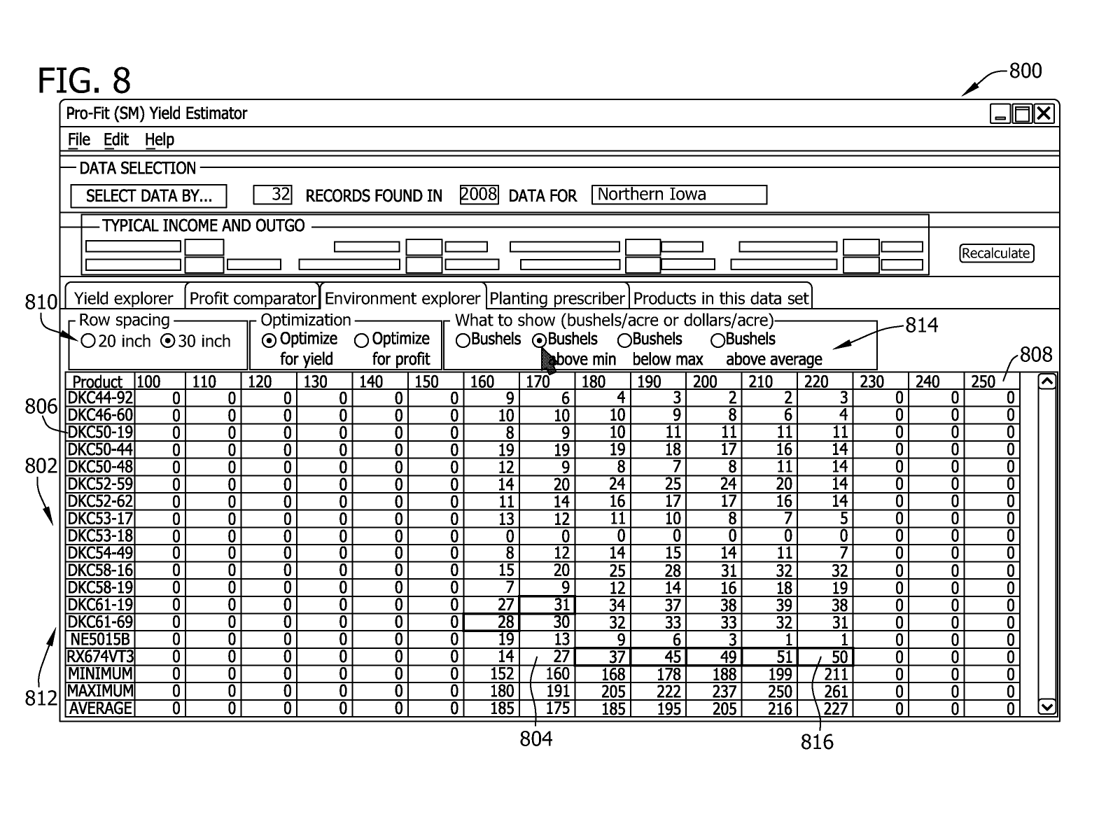

In addition, as shown in FIGS. 8-10, application server 204 updates, such as automatically updates, the displayed data based on user commands. For example, FIG. 8 is a view 800 of an exemplary predicted yield matrix 802 that displays a number of predicted bushels above a minimum 804 for each hybrid line 806 based on population density 808 and row spacing 810. View 800 includes a plurality of rows 812 that are each associated with a single hybrid line, and a plurality of columns 814 that are each associated with a single population density. In response to a selection of a different row spacing 810, application server 204 updates, such as automatically updates, matrix 802. As shown in FIG. 8, a highest number of predicted bushels above a minimum 816 for each population density 808 is highlighted.

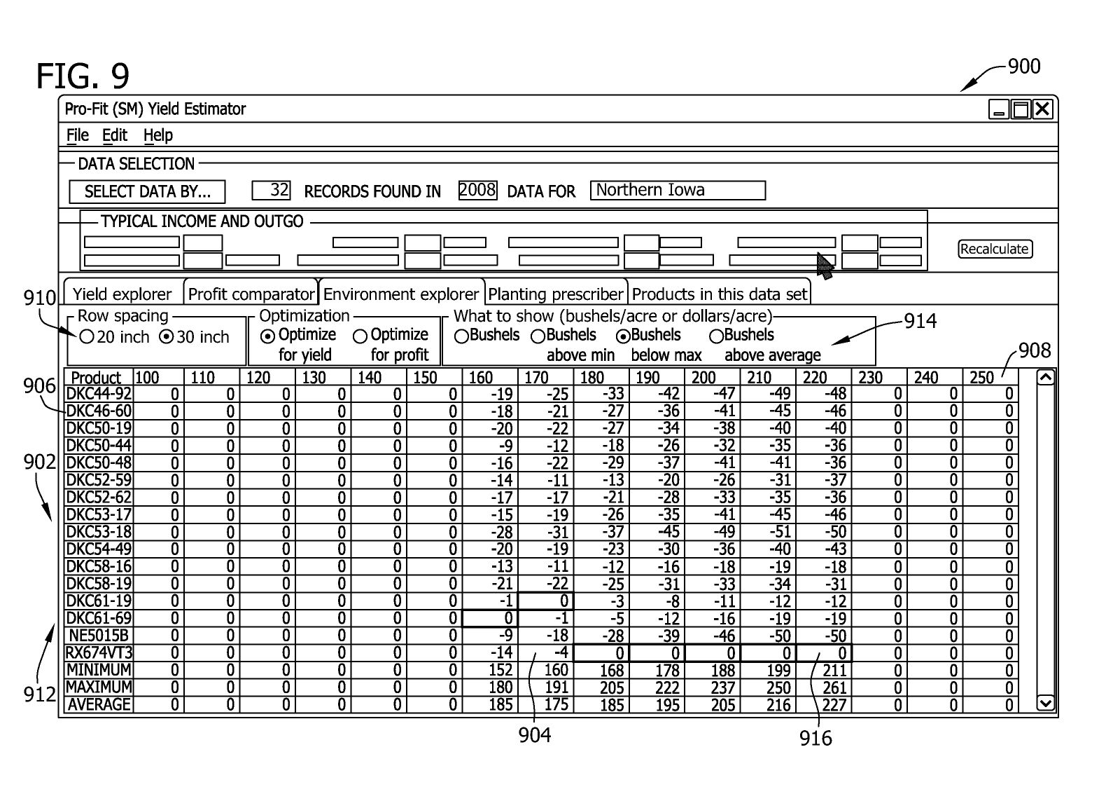

FIG. 9 illustrates a similar relationship. Specifically, FIG. 9 is a view 900 of an exemplary predicted yield matrix 902 that displays a number of predicted bushels below a maximum 904 for each hybrid line 906 based on population density 908 and row spacing 910. View 900 includes a plurality of rows 912 that are each associated with a single hybrid line, and a plurality of columns 914 that are each associated with a single population density. In response to a selection of a different row spacing 910, application server 204 updates, such as automatically updates, matrix 902. As shown in FIG. 8, a highest number of predicted bushels below a maximum 916 for each population density 908 is highlighted.

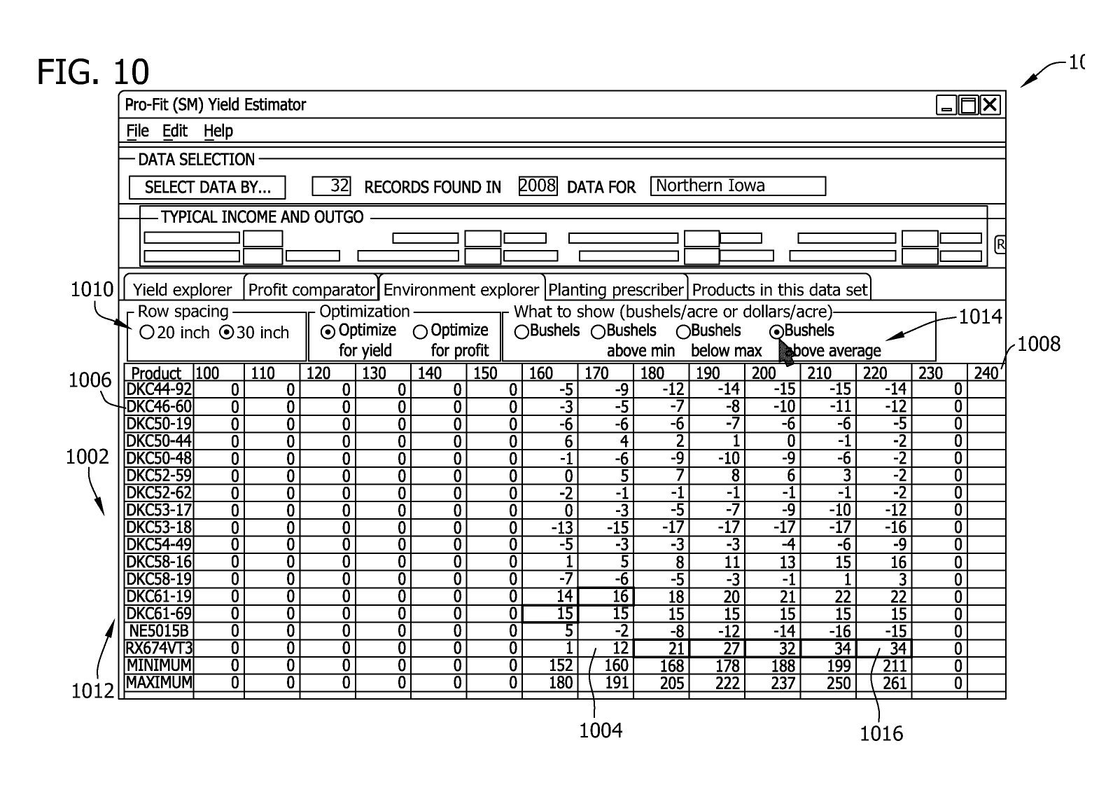

Moreover, FIG. 10 is a view 1000 of an exemplary predicted yield matrix 1002 that displays a number of predicted bushels above an average value 1004 for each hybrid line 1006 based on population density 1008 and row spacing 1010. View 1000 includes a plurality of rows 1012 that are each associated with a single hybrid line, and a plurality of columns 1014 that are each associated with a single population density. In response to a selection of a different row spacing 1010, application server 204 updates, such as automatically updates, matrix 1002. As shown in FIG. 8, a highest number of predicted bushels above an average value 1016 for each population density 1008 is highlighted.

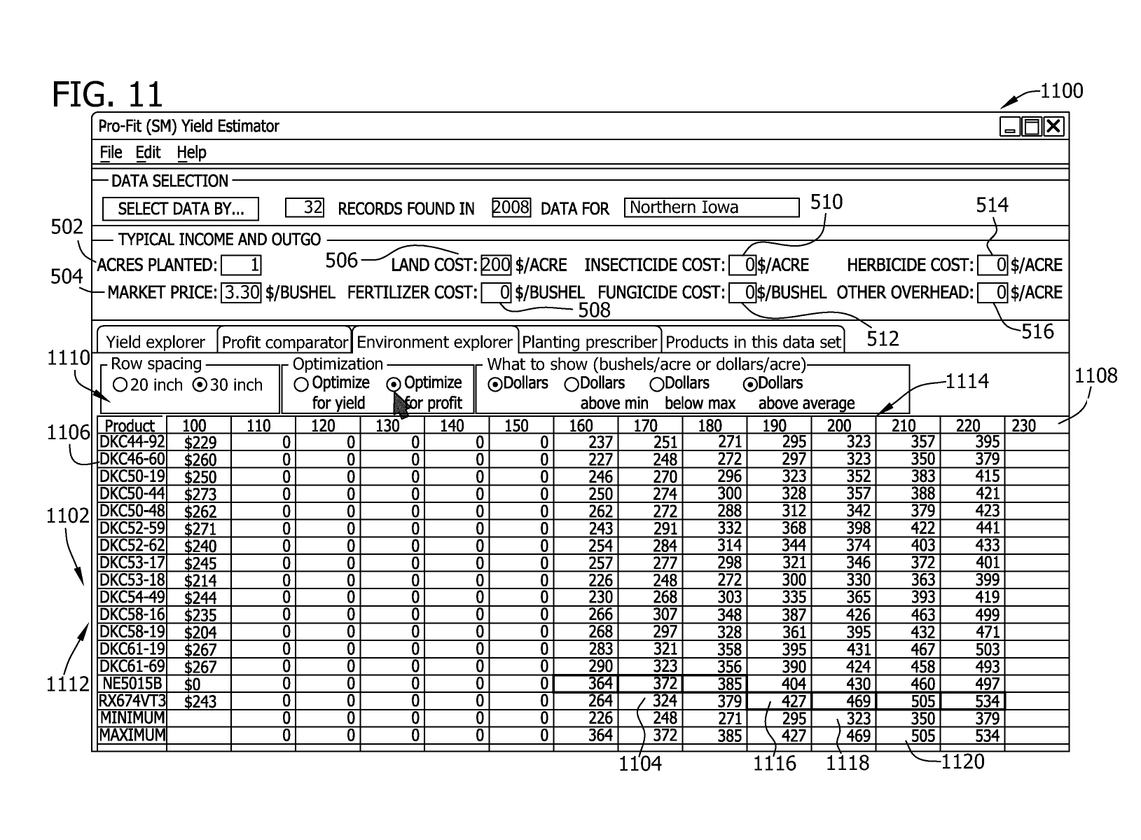

FIG. 11 is a view 1100 of an exemplary predicted profit matrix 1102 that displays a predicted profit 1104 for each hybrid line 1106 based on population density 1108 and row spacing 1110. Predicted profit view 1100 includes a plurality of rows 1112 that are each associated with a single hybrid line, and a plurality of columns 1114 that are each associated with a single population density. In some embodiments, view 1100 includes only columns 1114 and rows 1112 that have associated profit data stored in memory area 106. In the exemplary embodiment, view 1100 includes predicted profit 1104 for a selected row spacing 1110. In response to a selection of a different row spacing 1110, application server 204 updates, such as automatically updates, matrix 1102. As shown in FIG. 11, a highest profit 1116 for each population density 1108 is highlighted. Moreover, matrix 1102 includes a minimum profit 1118, maximum profit 1120, and average profit (not shown) for each population density 1108. Although not illustrated in the figures, application server 204 is configured to generate supplemental matrices related to profits similar to those described above in FIGS. 8-10.

In the exemplary embodiment, and referring again to FIG. 4, server system 102 generates and displays a crop prescription. Specifically, server system 102 receives 424 one or more selections of a hybrid line and population density in one or more of views 700 through 1100. More specifically, a user selects one or more desired hybrid lines based on the data shown in any one or more of views 700 through 1100. In some embodiments, the user may select the desired hybrid lines via a computer, such as workstations 220, 222, 224, 226, and 228, or via mobile device 234. In response to the selection of the desired hybrid lines, server system 102 generates 426 a crop prescription and presents the crop prescription for display. More specifically, application server 204 generates the crop prescription and presents the crop prescription for display. In an alternative embodiment, application server 204 automatically generates the crop prescription using the highest yield 716 (shown in FIG. 7) and/or the highest profit 1116. Application server 204 then determines 428 whether additional user selections of hybrid lines and population densities have been received. If addition selections have been received 424, application server 204 again generates 426 a crop prescription and presents the crop prescription for display.

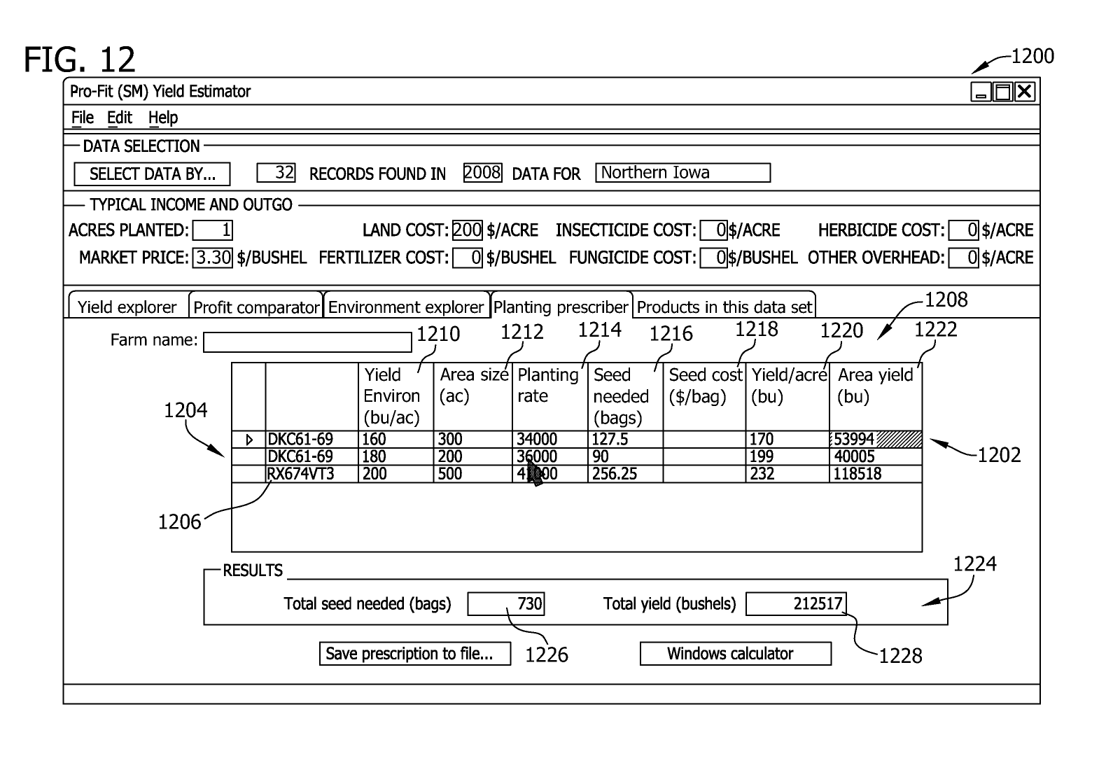

FIG. 12 is a view 1200 of an exemplary crop prescription 1202. In the exemplary embodiment, crop prescription 1202 includes a row 1204 that identifies each selected hybrid line 1206 and columns 1208 of data associated with each hybrid line 1206. Columns 1208 include population density 1210, area size 1212, planting rate 1214, seed bags needed 1216, seed cost per bag 1218, yield per acre 1220, and area yield 1222. Population density 1210 and yield per acre 1220 are the same data shown in view 700. In the exemplary embodiment, area size 1212 is the same data entered by the user in FIG. 5. Planting rate 1214 represents a number of seeds planted per a specified area. Seed bags needed 1216 represents a number of bags of seed of hybrid line 1206 needed to plant area size 1212 at planting rate 1214. Area yield 1222 represents a total predicted yield for hybrid line 1206 in area size 1212. In the exemplary embodiment, view 1200 also includes a results portion 1224 that includes a total number of bags of seed needed 1226 and a total yield 1228. Total number of bags needed 1226 is obtained by adding seed bags needed 1216 for each hybrid line 1206, and total yield 1228 is obtained by adding area yield 1222 for each hybrid line 1206.

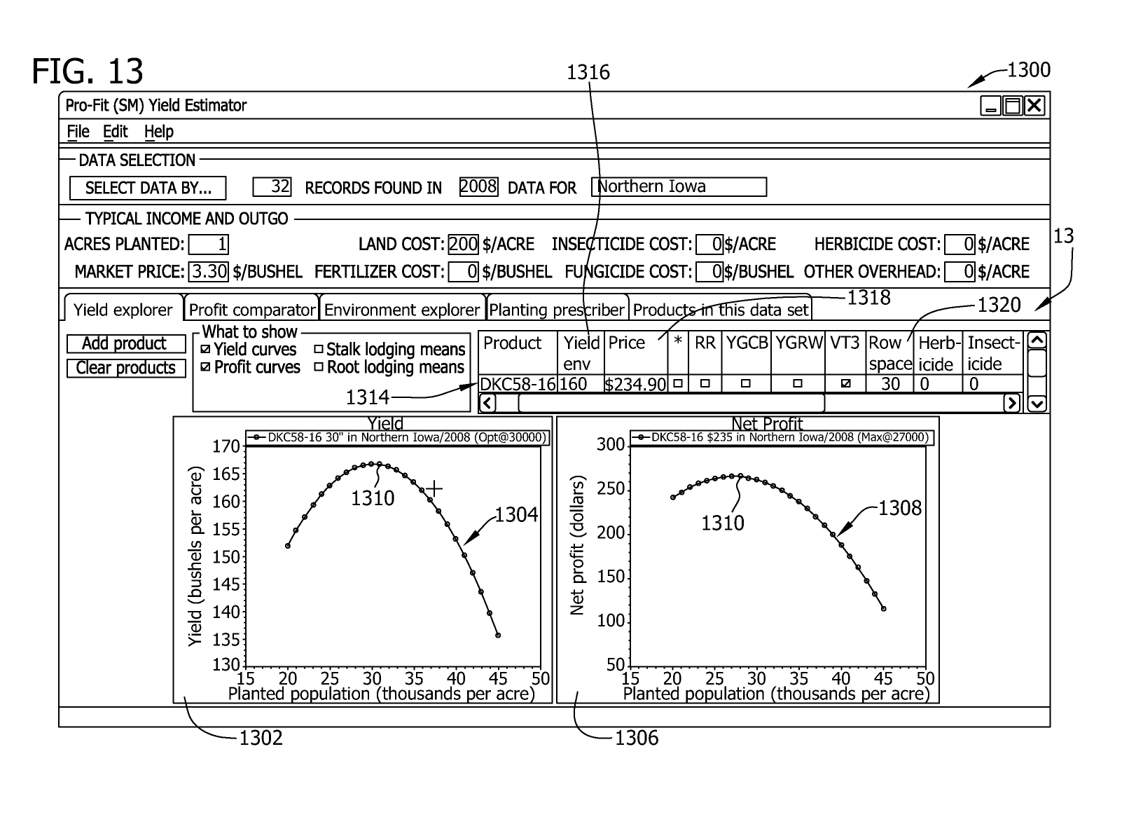

In the exemplary embodiment, and referring again to FIG. 4, server system 102 receives 430 a selection of one or more hybrid lines from the crop prescription. Based on the selected hybrid lines, server system 102 generates 432 a yield curve and generates 434 a profit curve. Specifically, application server 204 receives the selection of the one or more hybrid lines and generates the yield and profit curves. The yield and profit curves may be two-dimensional or three-dimensional. A two-dimensional yield curve compares yield and population density and a two-dimensional profit curve compares profit and population density. A three-dimensional yield curve compares yield and population density for each region within the yield population trials. Similarly, a three-dimensional profit curve compares profit and population density for each region within the yield population trials. FIG. 13 is a view 1300 that includes a yield comparison 1302 having a two-dimensional yield curve 1304, and a profit comparison 1306 having a two-dimensional profit curve 1308. Each curve 1304 and 1308 includes a plurality of data points 1310. A user may add additional hybrid lines to yield curve 1304 and/or profit curve 1308. When an additional hybrid line is selected, application server 204 generates an associated yield curve 1304 in yield comparison 1302 and/or generates an associated profit curve 1308 in profit comparison 1306. In addition, view 1300 includes a hybrid line information portion 1312 that displays the selected hybrid line 1314 and data associated with the selected hybrid line. The data includes population density 1316, price 1318 for each seed bag, row spacing 1320, and other suitable costs. Information portion 1312 includes a row for each selected hybrid 1314.

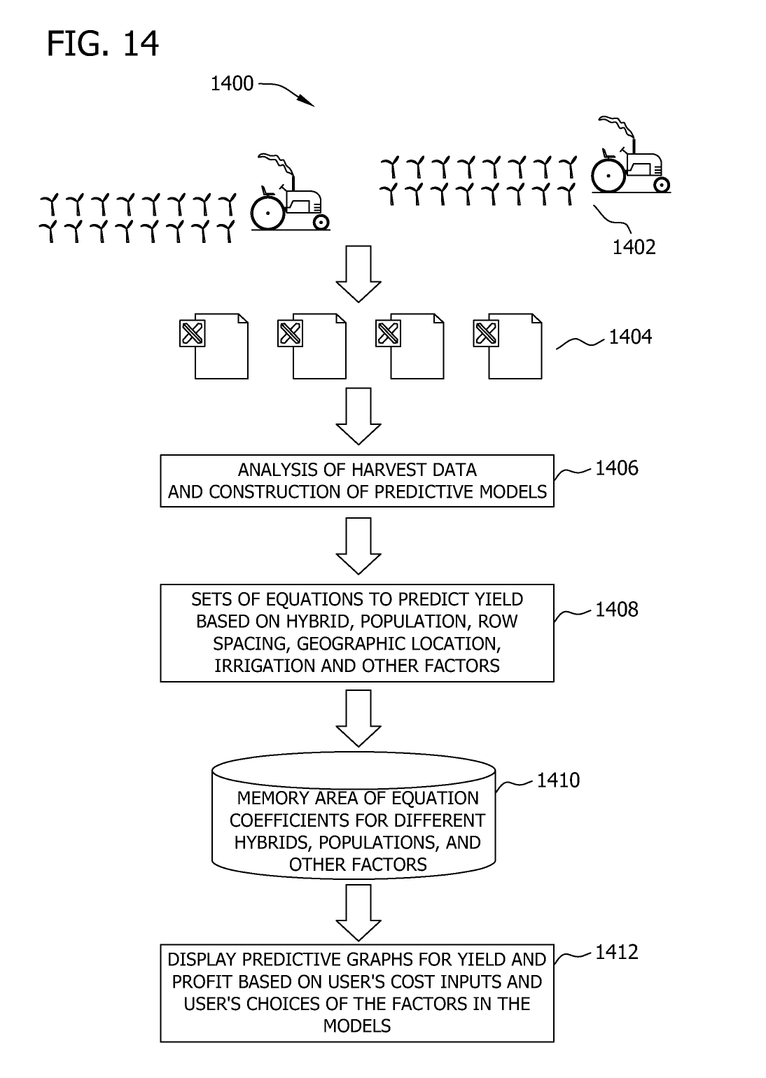

FIG. 14 a simplified block diagram of an exemplary crop prescription process 1400. In the exemplary embodiment, a grower plants and harvests 1402 a plurality of plots that compare a plurality of individual hybrid lines at a plurality of population densities, and using a plurality of row spacings. After the crops are harvested, the yield for each plot is aggregated 1404 to generate yield data within each plot and for each of a plurality of regions that include the plots.

Moreover, in the exemplary embodiment, statistical analysis of the yield data is used 1406 to create predictive models. The predictive models are further analyzed 1408 to generate yield values based on predictive model coefficients that relate to such factors as hybrid line, population density, row spacing, geographic location, irrigation, and any other suitable factors. The yield values and coefficients are stored 1410 in a memory area.

A user, such as an agronomist, seed sales representative, or grower, uses a program that generates and displays 1412 predictive graphs for yield and profit based on the user's cost inputs and choices of the above factors. The program includes an interface whereby the user inputs criteria for a given farm location. The inputs are used along with total acreage and an expected contract price of a crop to calculate optimum population by hybrid to provide an effective comparison of potential yield and profit. Accordingly, embodiments described herein provide graphical predictions of agricultural product yields and the profits realized from those yields. The predictions are generated using statistical models, which are constructed using sample farm harvest data.

Exemplary embodiments of systems, methods, computers, and computer-readable storage media for generating agricultural information products are described above in detail. The systems, methods, computers, and media are not limited to the specific embodiments described herein but, rather, operations of the methods and/or components of the system and/or apparatus may be utilized independently and separately from other operations and/or components described herein. Further, the described operations and/or components may also be defined in, or used in combination with, other systems, methods, computers, and/or apparatus, and are not limited to practice with only the systems, methods, computers, and media as described herein.

A computing device or computer such as described herein has one or more processors or processing units and a system memory. The computer typically has at least some form of computer readable media. By way of example and not limitation, computer readable media include computer storage media and communication media. Computer storage media include volatile and nonvolatile, removable and non-removable media implemented in any method or technology for storage of information such as computer readable instructions, data structures, program modules, or other data. Communication media typically embody computer readable instructions, data structures, program modules, or other data in a modulated data signal such as a carrier wave or other transport mechanism and include any information delivery media. Those skilled in the art are familiar with the modulated data signal, which has one or more of its characteristics set or changed in such a manner as to encode information in the signal. Combinations of any of the above are also included within the scope of computer readable media.

Although described in connection with an exemplary computing system environment, embodiments of the invention are operational with numerous other general purpose or special purpose computing system environments or configurations. The computing system environment is not intended to suggest any limitation as to the scope of use or functionality of any aspect of the invention. Moreover, the computing system environment should not be interpreted as having any dependency or requirement relating to any one or combination of components illustrated in the exemplary operating environment. Examples of well known computing systems, environments, and/or configurations that may be suitable for use with aspects of the invention include, but are not limited to, personal computers, server computers, hand-held or laptop devices, multiprocessor systems, microprocessor-based systems, set top boxes, programmable consumer electronics, mobile telephones, network PCs, minicomputers, mainframe computers, distributed computing environments that include any of the above systems or devices, and the like.

Embodiments of the invention may be described in the general context of computer-executable instructions, such as program components or modules, executed by one or more computers or other devices. Aspects of the invention may be implemented with any number and organization of components or modules. For example, aspects of the invention are not limited to the specific computer-executable instructions or the specific components or modules illustrated in the figures and described herein. Alternative embodiments of the invention may include different computer-executable instructions or components having more or less functionality than illustrated and described herein.

The order of execution or performance of the operations in embodiments of the invention illustrated and described herein is not essential, unless otherwise specified. That is, the operations may be performed in any order, unless otherwise specified, and embodiments of the invention may include additional or fewer operations than those disclosed herein. For example, it is contemplated that executing or performing a particular operation before, contemporaneously with, or after another operation is within the scope of aspects of the invention.

In some embodiments, a processor includes any programmable system including systems and microcontrollers, reduced instruction set circuits (RISC), application specific integrated circuits (ASIC), programmable logic circuits (PLC), and any other circuit or processor capable of executing the functions described herein. The above examples are exemplary only, and thus are not intended to limit in any way the definition and/or meaning of the term processor.

In some embodiments, a database includes any collection of data including hierarchical databases, relational databases, flat file databases, object-relational databases, object oriented databases, and any other structured collection of records or data that is stored in a computer system. The above examples are exemplary only, and thus are not intended to limit in any way the definition and/or meaning of the term database. Examples of databases include, but are not limited to only including, Oracle® Database, MySQL®, IBM® DB2, Microsoft® SQL Server, Sybase®, and PostgreSQL. However, any database may be used that enables the systems and methods described herein. (Oracle is a registered trademark of Oracle Corporation, Redwood Shores, Calif.; MySQL is a registered trademark of MySQL AB, Menlo Park, Calif.; IBM is a registered trademark of International Business Machines Corporation, Armonk, N.Y.; Microsoft is a registered trademark of Microsoft Corporation, Redmond, Wash.; and Sybase is a registered trademark of Sybase, Dublin, Calif.)

When introducing elements of aspects of the invention or embodiments thereof, the articles “a,” “an,” “the,” and “said” are intended to mean that there are one or more of the elements. The terms “comprising,” including,” and “having” are intended to be inclusive and mean that there may be additional elements other than the listed elements.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A method for generating a crop prescription using a computer coupled to a memory area, the method comprising:
receiving, by the computer, yield data for a plurality of crop population trials, wherein each trial is varied by at least one of a hybrid line, a population density, and a row spacing;
generating, by the computer, at least one statistical model based on the yield data to obtain a plurality of coefficients and storing the coefficients in the memory area;
determining, by the computer, a predicted yield for at least one selected hybrid line based on the coefficients and a selected row spacing;
determining, by the computer, a predicted profit for the at least one selected hybrid line based on the coefficients and the selected row spacing; and
presenting a crop prescription that includes a recommended hybrid line and population density for use by a grower.

2. The method according to claim 1, further comprising presenting a crop prediction matrix that includes a plurality of rows of hybrid lines and a plurality of columns of population densities.

3. The method according to claim 2, wherein determining a predicted yield for at least one selected hybrid line comprises determining a predicted yield for each hybrid line at each population density.

4. The method according to claim 2, wherein determining a predicted yield for at least one selected hybrid line comprises determining a highest yield for each population density.

5. The method according to claim 2, wherein determining a predicted profit for the at least one selected hybrid line comprises determining a predicted profit for each hybrid line at each population density.

6. The method according to claim 2, wherein determining a predicted profit for at least one selected hybrid line comprises determining a highest profit for each population density.

7. The method according to claim 2, further comprising receiving a selection of the at least one hybrid line with an associated row spacing and population density.

8. The method according to claim 1, further comprising presenting a yield curve for the at least one selected hybrid line, wherein the yield curve includes a comparison of predicted yield and population density for the at least one selected hybrid line.

9. The method according to claim 8, wherein the at least one selected hybrid line includes a plurality of selected hybrid lines, said presenting a yield curve comprises presenting a plurality of yield curves.

10. The method according to claim 1, further comprising presenting a three-dimensional yield curve for the at least one selected hybrid line, wherein the yield curve includes a comparison of predicted yield and population density for each of a plurality of regions in the yield data.

11. The method according to claim 1, further comprising presenting a profit curve for the at least one selected hybrid line, wherein the profit curve includes a comparison of predicted profit and population density for the at least one selected hybrid line.

12. The method according to claim 11, wherein the at least one selected hybrid line includes a plurality of selected hybrid lines, said presenting a profit curve comprises presenting a plurality of profit curves.

13. The method according to claim 1, further comprising presenting a three-dimensional profit curve for the at least one selected hybrid line, wherein the profit curve includes a comparison of predicted profit and population density for each of a plurality of regions in the yield data.

14. A computer coupled to a memory area for use in crop optimization based on yield data for a plurality of crop population trials each varied by at least one of a crop hybrid line, a population density, and a row spacing, the computer programmed to:
receive a number of acres to be planted;
determine a predicted yield for each of a plurality of hybrid lines at each of a plurality of population densities based on a plurality of statistical model coefficients stored in the memory area;
determine a predicted profit for each of the plurality of hybrid lines at each of the plurality of population densities based on the statistical model coefficients;
receive a selected row spacing and at least one hybrid line associated with at least one selected population density; and
provide a number of seed bags of the at least one selected hybrid line necessary to plant the received number of acres.

15. The computer according to claim 14, further programmed to determine a predicted yield for each the plurality of hybrid lines based on the selected row spacing.

16. The computer according to claim 14, further programmed to determine a predicted profit for each the plurality of hybrid lines based on the selected row spacing.

17. The computer according to claim 14, further programmed to present a crop prediction matrix that includes a plurality of rows of hybrid lines and a plurality of columns of population densities.

18. The computer according to claim 14, further programmed to present a yield curve for the at least one selected hybrid line, wherein the yield curve includes a comparison of predicted yield and population density for the at least one selected hybrid line.

19. The computer according to claim 14, further programmed to present a three-dimensional yield curve for the at least one selected hybrid line, wherein the yield curve includes a comparison of predicted yield and population density for each of a plurality of regions in the yield data.

20. The computer according to claim 14, further programmed to present a profit curve for the at least one selected hybrid line, wherein the profit curve includes a comparison of predicted profit and population density for the at least one selected hybrid line.

21. The computer according to claim 14, further programmed to present a three-dimensional profit curve for the at least one selected hybrid line, wherein the profit curve includes a comparison of predicted profit and population density for each of a plurality of regions in the yield data.

22. One or more computer-readable storage media having computer-executable components for generating a crop prescription using a computer coupled to a memory area, the components comprising:
a data reception component that when executed by at least one processor causes the at least one processor to receive yield data for a plurality of crop population trials, wherein each trial is varied by at least one of a hybrid line, a population density, and a row spacing;
a statistics component that when executed by at least one processor causes the at least one processor to generate at least one statistical model based on the yield data to obtain a plurality of coefficients;
a yield prediction component that when executed by at least one processor causes the at least one processor to determine a predicted yield for at least one selected hybrid line based on the coefficients;
a profit prediction component that when executed by at least one processor causes the at least one processor to determine a predicted profit for the at least one selected hybrid line based on the coefficients; and
a prescription component that when executed by at least one processor causes the at least one processor to present a crop prescription that includes a recommended hybrid line and population density for use by a grower.

23. The computer-readable storage media according to claim 22, wherein the yield prediction component determines a predicted yield for the at least one selected hybrid line based on a selected row spacing, and wherein the profit prediction component determines a predicted profit for the at least one selected hybrid line based on a selected row spacing.

24. The computer-readable storage media according to claim 22, wherein:
the statistics component presents a crop prediction matrix that includes a plurality of rows of hybrid lines and a plurality of columns of population densities;
the yield prediction component determines a predicted yield for each hybrid line at each population density; and
the profit prediction component determines a predicted profit for each hybrid line at each population density.

25. The computer-readable storage media according to claim 22, wherein the yield prediction component presents a yield curve for the at least one selected hybrid line, the yield curve including a comparison of predicted yield and population density for the at least one selected hybrid line, and wherein the profit prediction component presents a profit curve for the at least one selected hybrid line, the profit curve including a comparison of predicted profit and population density for the at least one selected hybrid line.

26. The computer-readable storage media according to claim 22, wherein the yield prediction component presents a three-dimensional yield curve for the at least one selected hybrid line, the yield curve including a comparison of predicted yield and population density for each of a plurality of regions in the yield data, and wherein the profit prediction component presents a three-dimensional profit curve for the at least one selected hybrid line, the profit curve includes a comparison of predicted profit and population density for each of a plurality of regions in the yield data.

27. A system configured to generate a crop prescription for use by a grower, the system comprising:
a memory area configured to store yield data for a plurality of crop population trials that include a plurality of hybrid lines, population densities, and row spacings; and
a computer system coupled to the memory area, wherein the computer system is configured to:
determine a predicted yield for each a plurality of hybrid lines at each of a plurality of population densities based on a plurality of statistical model coefficients stored in the database and a selected row spacing;
determine a predicted profit for each the plurality of hybrid lines at each of the plurality of population densities based on the statistical model coefficients and the selected row spacing; and
present a crop prescription that includes at least one selected hybrid line, a population density, and a predicted yield for a user-input acreage using the at least one selected hybrid line and population density for use by a grower.

28. The system according to claim 27, wherein the computer system is configured to present a yield curve and a profit curve for the at least one selected hybrid line, wherein the yield curve includes a comparison of predicted yield and population density for the at least one selected hybrid line, and wherein the profit curve includes a comparison of predicted profit and population density for the at least one selected hybrid line.

29. The system according to claim 28, wherein the at least one selected hybrid line includes a plurality of selected hybrid lines, and wherein the computer is further programmed to present a plurality of yield curves and profit curves.

30. The system according to claim 27, the computer system is configured to present at least one of a three-dimensional yield curve and a three-dimensional profit for the at least one selected hybrid line, wherein the yield curve includes a comparison of predicted yield and population density for each of a plurality of regions in the yield data, and wherein the profit curve includes a comparison of predicted profit and population density for each of a plurality of regions in the yield data.
